(19) United States
(12) Patent Application Publication
(10) Pub. No.: US 2014/0197172 A1
(43) Pub. Date: Jul. 17, 2014

(54) Lid securing device and refuse container including same.

(71) Applicant: Francis Magny, Tres St-Redempteur (CA)

(72) Inventor: Francis Magny, Tres St-Redempteur (CA)

(21) Appl. No.: 14/149,380

(22) Filed: Jan. 7, 2014

(30) Foreign Application Priority Data
Jan. 17, 2013 (GB) 1300830.5

(51) Int. Cl. B65F 1/14

(52) U.S. Cl. CPC B65F 1/1615
USPC 220/318; 220/729

(57) ABSTRACT

A lid securing device for a refuse container comprising: a stretchable element including a substantially elongated, resiliently stretchable and flexible stretchable element bod which defines substantially opposed stretchable element body ends, the stretchable element also including two attachment elements each mounted to the stretchable element body adjacent a respective one of the stretchable element body ends, each of the attachment elements being attachable to a lid attachment defined by a lid of the refuse container. The lid securing device also includes a clip mounted to the stretchable element between the stretchable element body ends and releasably attachable to a receptacle attachment defined by a receptacle of the refuse container to which the lid is mounted.

### FIELD OF THE INVENTION

The present invention relates generally to lid securing devices and, more particularly, to a lid securing device for releasably securing the lid of a refuse container and to a refuse container including the same.

### BACKGROUND

The prior art proposes numerous lid securing devices for refuse containers. The lid securing devices of the prior art generally include a resiliently stretchable member having elastomeric or spring like properties to which are attached one or more hook means adapted for engaging selected portions of a refuse container such as, for examples, handles and/or container edges.

Typical examples of the prior art are U.S. Pat. Appl. No. US2010/0200604A1 to Sharma et al. (published in August 2010), US2010/0001013A1 to Sommerfield (published in January 2010), US2009/0223987A1 to Wang (published in September 2009) and US2007/0175898A1 to Craft et al., (published in August 2007), and U.S. Pat. No. 3,589,760 to Williams (issued in June 1971).

While these prior art devices can generally fulfill the main objective of securing the lid on the base of a refuse container, they also entail one or more of the following disadvantages.

Lid securing devices of the prior art generally require both hands of the user to operate when it is required to temporarily open the lid of the refuse container in order to add garbage or recyclable material therein. This disadvantage forces a user to deposit, for example, small refuse bags on the ground each time before releasing the device from the lid. And, of course, both hands are again required to lock the container lid in a closed configuration with the device.

Furthermore, these lid securing devices of the prior art generally do not remain engaged to at least a portion of the refuse container while not securing the container lid in a closed configuration. Thus, a user is generally obliged to hold the device with one hand or keep it pressed under one arm while he or she lifts the lid to add content to the refuse container, which can represent a particularly annoying operation.

Against this background, there exists a need for an improved lid securing device for a refuse container and/or improved refuse container.

It is a general object of the present invention to provide an improved lid securing device for a refuse container and an improved refuse.

### SUMMARY OF THE INVENTION

In a broad aspect, the invention provides a lid securing device for a refuse container, the refuse container including a receptacle defining a top aperture, the refuse container also including a lid for selectively obstructing the top aperture, the lid defining a pair of lid attachments and the receptacle defining a receptacle attachment, the lid securing device comprising: a stretchable element, the stretchable element including a stretchable element body, the stretchable element body being substantially elongated, flexible and resiliently stretchable, the stretchable element body defining substantially opposed stretchable element body ends, the stretchable element also including two attachment elements each mounted to the stretchable element body substantially adjacent a respective one of the stretchable element body ends, each of the attachment elements being attachable to a respective one of the lid attachments; and a clip defining a clip first end section, a clip second end section and a clip intermediate section extending therebetween, the clip first end section being mounted to the stretchable element between the stretchable element body ends, the clip second end section being releasably attachable to the receptacle attachment. When the attachment elements are attached to the lid attachments, the stretchable element body is stretchable by pulling on the clip so that the clip second end section can be attached to the receptacle attachment to secure the lid in a lid closed position in which the lid obstructs the top aperture.

In some embodiments of the invention, the attachment elements each include a hook.

In some embodiments of the invention, wherein the attachment elements are removably attachable to the lid attachments.

In some embodiments of the invention, the clip first end section defines a passageway receiving at least part of the stretchable element body therethrough.

In some embodiments of the invention, the clip intermediate section is selectively adjustable in length to selectively vary a distance between the clip first and second end sections.

In some embodiments of the invention, the clip is substantially rigid. For example, the clip intermediate section includes intermediate section first and second portions, the intermediate section first ans second portions being substantially planar and angled relative to each other.

In some embodiments of the invention, the clip second end section is substantially V-shaped and defines a recess for receiving the receptacle attachment thereinto.

In another broad aspect, the invention provides a refuse container, the refuse container comprising: a receptacle defining a top aperture and a receptacle attachment; a lid, the lid defining substantially opposed lid first and second ends, the lid being hingedly mounted to the receptacle opposed to the receptacle attachment at the lid first end, the lid being movable between a lid open position and a lid closed position, the lid being removed from the top aperture in the lid open position and the lid obstructing the top aperture in the lid closed position, the lid defining a pair of lid attachments substantially adjacent the lid second end; and a lid securing device including: a stretchable element, the stretchable element including a stretchable element body, the stretchable element body being substantially elongated, flexible and resiliently stretchable, the stretchable element body defining substantially opposed stretchable element body ends, the stretchable element also including two attachment elements each mounted to the stretchable element body substantially adjacent a respective one of the stretchable element body ends, each of the attachment elements being attached to a respective one of the lid attachments; and a clip defining a clip first end section, a clip second end section and a clip intermediate section extending therebetween, the clip first end section being mounted to the stretchable element between the stretchable element body ends, the clip second end section being releasably attachable to the receptacle attachment when the lid is in the lid closed position; the lid securing device being reversibly movable between an unlocked position and a locked position, wherein, in the unlocked position, the clip second end section is detached from the receptacle attachment and the stretchable element body has a body first length, and, in the locked position, the clip second end section is attached to the receptacle attachment and the stretchable element body has a body second length longer than the body first length and is deformed towards the receptacle attachment.

In some embodiments of the invention, the lid defines a pair of handles, the handles defining the lid attachments.

In some embodiments of the invention, the attachment elements each include a hook.

In some embodiments of the invention, the attachments element are detachable from the lid attachments.

In some embodiments of the invention, the body first length is larger or equal to an unstretched length of the stretchable element body.

In some embodiments of the invention, the clip first end section defines a passageway receiving at least part of the stretchable element body therethrough.

In some embodiments of the invention, the receptacle defines a receptacle flange extending peripherally relative to the top aperture and a lip extending downwardly from the receptacle flange at the outer periphery thereof, the lip defining the receptacle attachment, the clip second end section being attached to the lip when the lid securing device is in the locked position.

In some embodiments of the invention, the clip is substantially rigid and the clip intermediate section includes intermediate section first and second portions, the intermediate section first and second portions extending respectively from the clip first and second end sections, the intermediate section first and second portions being substantially planar and angled relative to each other, the intermediate section second portion abutting against and being substantially parallel to the lip when the lid securing device is in the locked position. For example, the clip second end section is substantially V-shaped and defines a recess receiving at least part of the lip thereinto when the lid securing device is in the locked position. In a specific example, the clip second end section defines a notch extending substantially longitudinally thereinto.

In some embodiments of the invention, the clip is a made of a single piece of folded sheet metal.

The lid securing device is particularly useful for selectively securing in a closed position the lid of the refuse container for preventing access to the content thereof by domestic or wild animals such as dogs and raccoons. Furthermore, the lid securing device may also be particularly useful for preventing the content of the refuse container from being spilled on the street in the event that it is toppled over by wind or a vehicle.

The lid securing device of the present invention is suitably adapted for releasably securing in a closed position the lid of a type of wheeled refuse container that is commonly imposed for domestic use by municipal organizations using garbage and/or recycling pickup trucks equipped with an automatically operated container pickup arm. The typically configured refuse container that is concerned with the present invention generally comprises the hinged container lid having a pair of handles distally disposed along a top surface thereof, and a base container defining a substantially downwardly extending lip peripherally relative to the peripheral edge of its top aperture.

Thus, the present invention provides a manner of positively securing a hinged lid in a closed configuration on the receptacle of a refuse container. In some embodiments, the lid securing device of the present invention can be operated using a single hand. Furthermore, the present invention provides a lid securing device that can remain removably engaged with the lid even when the clip is not securing the hinged lid in a close configuration on the refuse container.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates a lid securing device in accordance with an embodiment of the present invention;

FIG. 2, in a perspective view, illustrates the lid securing device of FIG. 1 having attachment elements thereof attached to the handles of the lid of a partially shown typical refuse container, the lid securing device being shown in an unlocked position;

FIG. 3, in a perspective view, illustrates the lid securing device of FIG. 2 further having a clip thereof resiliently engaged on a substantially centered, front edge portion of the closed lid on the receptacle of the partially shown refuse container, the lid securing device being shown in a locked position;

FIG. 4, in side plan view, illustrates the clip shown in FIGS. 2 and 3 when the lid securing device is in a position intermediate the locked and unlocked positions;

FIG. 5, in side plan view, illustrates the clip shown in FIGS. 1 to 4 when the lid securing device is in the locked and position;

FIG. 6, in a side plan view, illustrate an alternate embodiment of a clip usable in a lid securing device in accordance with the invention;

FIG. 7, in a perspective view, illustrates another alternate embodiment of a clip usable in a lid securing device in accordance with the invention;

FIG. 8, in a perspective view, illustrates a refuse container including a lid securing device having yet another alternate clip;

FIG. 9, in a perspective view, illustrates the clip shown in FIG. 8;

FIG. 10, in an alternative perspective view, illustrates the clip shown in FIGS. 8 and 9 mounted to the container shown in FIG. 8, the container being only partially shown; and

FIG. 11, in side elevation view, illustrates the clip shown in FIGS. 8 to 10 mounted to the container shown in FIGS. 8 and 10, the container being only partially shown.

### DETAILED DESCRIPTION

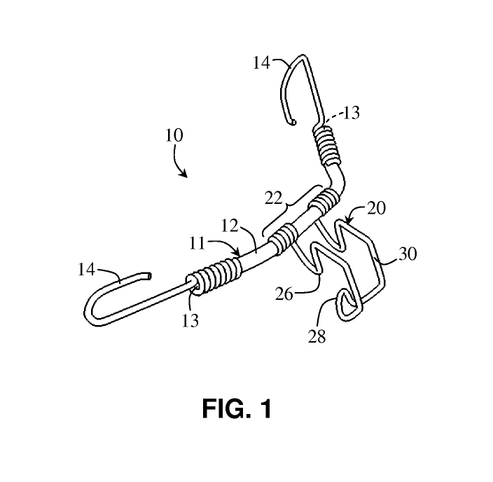

FIGS. 1 to 5 inclusively show various aspects of a lid securing device 10 according to an embodiment of the present invention. The lid securing device 10 is particularly useful for selectively securing in a closed position the lid of a refuse container 50 (not shown in FIG. 1) for preventing access to the content thereof by domestic or wild animals such as dogs and raccoons. Furthermore, the lid securing device 10 may also be particularly useful for preventing the content of the refuse container 50 from being spilled on the street in the event that it is toppled over by wind or a vehicle.

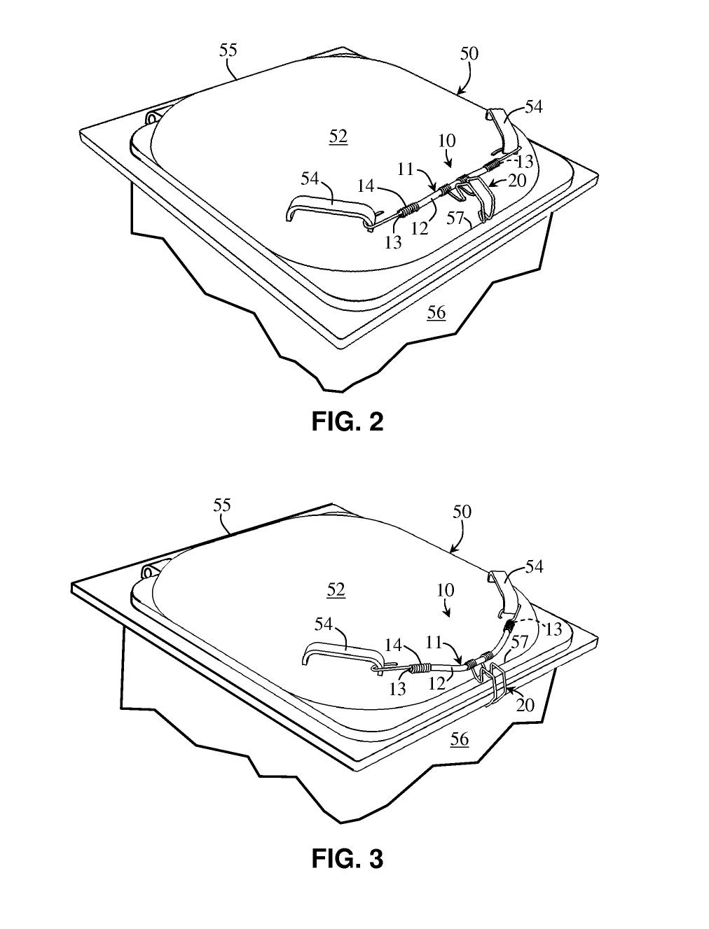

The lid securing device 10 of the present invention is adapted for releasably securing in a lid closed position the hinged lid 52 of a typically configured refuse container 50, as illustrated in partial view, for example, in FIG. 2. Such refuse container 50 configuration is commonly imposed for domestic use by municipal organizations that are using garbage and/or recycling pickup trucks equipped with an automatically operated container pickup arm.

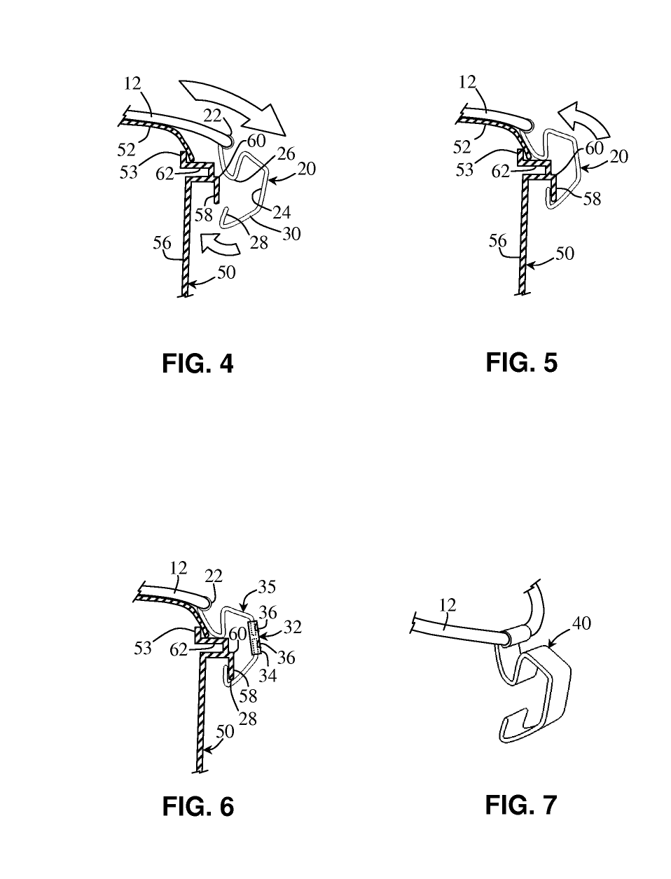

Such refuse containers 50 typically include a receptacle 56 (only partially shown in the drawings) and the lid 52. With reference to FIGS. 4 to 6, the receptacle 56 defines a top aperture 53 and a receptacle attachment 58. Returning to FIG. 2, the lid 52 defines substantially opposed lid first and second ends 55 and 57. The lid 52 is hingedly mounted to the receptacle 56 opposed to the receptacle attachment 58 at the lid first end 55 and is movable between conventional lid open and closed positions, only the latter being shown in the drawings. The lid 52 is removed from the top aperture 53 in the lid open position and the lid 52 obstructs the top aperture 53 in the lid closed position. The lid 52 defining a pair of lid attachments 54 substantially adjacent the lid second end 57. In the refuse container 50 shown in the drawings, the lid attachments 54 are defines as a pair of handles 54 disposed along a top surface of the lid 52. In this document, the terminology “handles” and “lid attachment” is used interchangeably, but the reader skilled in the art will understand that the proposed lid securing device is usable with any other type of lid attachments 44, such as, non-exclusively, special-purpose hooks or eyelet.

As best illustrated, for example, in FIGS. 4 to 6, in some embodiments of the invention, the receptacle 56 defines a receptacle flange 62 extending peripherally relative to the top aperture 53 and a lip 58 extending downwardly from the receptacle flange 62 at the outer periphery 60 thereof, the lip 58 being the receptacle attachment 58. It should be noted that in alternative embodiments of the invention, the lip 58 is omitted and another alternative structure of the receptacle 56 serves as the receptacle attachment 58. However, in the present document, the terminology “lip” and “receptacle attachment” is used interchangeably.

Now referring to FIG. 1, the lid securing device 10 includes a stretchable element 11 and a clip 20. The stretchable element 11 includes a stretchable element body 12. The stretchable element body 12 is substantially elongated, flexible and resiliently stretchable. For example, the stretchable element body 12 is made of an elastic cord of the type commonly known as a “bungee cord”. The stretchable element body 12 defines substantially opposed stretchable element body ends 13.

The stretchable element 11 also including a pair of attachment elements 14 mounted to the stretchable element body 12 substantially adjacent the stretchable element body ends 13. As seen for example in FIGS. 2 and 3, each of the attachment elements 14 is attached to a respective one of the lid attachments 54 when the lid securing device 10 is attached to the refuse container 50 in an operational configuration. In some embodiments of the invention, the attachment elements 14 each take the form of a hook 14.

Returning to FIG. 1, the clip 20 defines a clip first end section 22, a clip second end section 28 and a clip intermediate section 30 extending therebetween. The clip first end section 22 is mounted to the stretchable element 11 between the stretchable element body ends 13 and the clip second end section 28 is releasably attachable to the receptacle attachment 58 when the lid 52 is in the lid closed position. In the embodiment of the invention shown in FIG. 1, the clip first end section 22 is fixedly attached to a substantially centered portion of the stretchable element body 12, but other configurations are within the scope of the invention.

The clip 20 is for example made of a resilient yet sufficiently rigid and rust proof material such as, for examples, stainless steel, aluminum, or a suitable polymeric material. Referring to FIG. 4, the clip 20 defines in the clip intermediate section 30 a substantially C-shaped recess 24 that is suitably sized and configured for resiliently engaging the flange 62 and a lower edge portion of the lip 58.

The C-shaped recess 24 defines a clip first end section protrusion 26 that is suitably configured and sized for resiliently abutting against the flange 62 of the receptacle 56. The clip first end section protrusion 26 protrudes towards the clip second end section 28 and forms the entrance of the C-shaped recess 24 therewith. The C-shaped recess 24 further defines the clip second end section 28 that is suitably configured and sized to form a hook for firmly engaging a lower edge portion of the lip 58.

In some embodiments, the clip 20 may be made out of a metal wire that is suitably bended and configured to form the C-shaped recess 24 and the clip first and second end sections 22 and 28 for attachment with the stretchable element body 12. The metal wire is preferably made of a rust proof and substantially rigid metal that is bent and configured to form the clip 20 using a conventional multi-step bending process known in the art.

The stretchable element body 12 may be represented by an elongated band or rope made of a material or a combination of materials such as, for examples, rubber, a rubber string enveloped in a Nylon® mesh, a synthetic polymer having rubber-like properties, or an elongated coil spring. Other equivalent materials having elastomeric properties are also possible.

The attachment elements 14 may be made of any suitably rigid material such as, for example, metal, plastic, a high-impact ABS (acrylonitrile-butadiene-styrene copolymers), or the likes. As exemplified in the drawings, the attachment elements 14 may be made of the same the metallic wire used for the clip 20. It is to be understood that other equivalent attachment elements 14 are usable, as long as they can be attached to the lid attachments 54. A non-exclusive example of such an alternative attachment element would be a carabiner.

Typically, the stretchable element body 12 and the attachment elements 14 are suitably sized and shaped such that, when the lid securing device 10 has only its pair of attachment elements 14 engaged on the opposed lid attachments 54 of the lid 52, as illustrated in FIG. 2, the attachment elements 14 are substantially prevented from self disengaging from the handles 54.

For example, as exemplified in the drawings, the overall length of the combined stretchable element body 12 and attachment elements 14 is typically equal to or slightly shorter than the shortest distance separating the lid handles 54. Furthermore, the handle engaging portion of the attachment elements 14 is preferably suitably sized and configured for surrounding a substantial portion of the cross-section of a handle 54.

Furthermore, typically, the stretchable element body 12 is sufficiently stretchable such that, with the lid securing device 10 having its attachment elements 14 engaged on the distally opposed lid handles 54, a user may single-handedly pull on the clip 20 and resiliently engage the latter on the lip 58 of the refuse container 50, as illustrated in FIG. 3, without requiring excessive force.

The lid securing device 10 is thus reversibly movable between an unlocked position (seen for example in FIG. 2) and a locked position (seen for example in FIG. 3). In the unlocked position, the clip second end section 28 is detached from the receptacle attachment 58 and the stretchable element body 12 has a body first length. In the locked position, the clip second end section 28 is attached to the receptacle attachment 58 and the stretchable element body 12 has a body second length longer than the body first length and is deformed towards the receptacle attachment 58. Typically, the body first length is larger or equal to an unstretched length of the stretchable element body 12 so as to secure the lid securing device 10 to the lid 52 when in the unlocked position.

A mode of usage of the lid securing device 10 is now described. To secure the lid 52 in the lid closed position on the receptacle 56, in a first step, the stretchable element body 12 is sufficiently stretched in order to engage the pair of attachment elements 14 on the pair of opposed handles 54, as illustrated in FIG. 2, which achieves the unlocked position. In a second step, the clip 20 is sufficiently pulled toward the front edge portion of the closed refuse container 50, followed with attaching the clip second end section 28 of the clip 20 along a substantially centered, lower front edge portion of the lip 58. In a third step, the clip first end section protrusion 26 of the clip 20 is resiliently engaged along the top surface of the flange 62 of the receptacle 56 such that the lid 52 is firmly secured in a closed position on the receptacle 56, as illustrated in FIG. 3.

In a fourth step, for allowing the opening of the lid 52, the second and third steps described above are simply executed in a reverse order. The lid securing device 10 may be typically left hooked to the handles 54 for subsequent use. However, the attachment elements 14 are typically are detachable from the lid attachments 54 so that the lid securing device 10 can be removed or replaced if needed. However, in alternative embodiments of the invention, the attachment elements 14 are permanently secured to the lid attachments 54.

FIG. 6 illustrates an alternate embodiment of a clip 35 usable in a lid securing device according to the invention. The clip 35 is substantially similar to the clip 20 of the first embodiment described hereinabove, except that the clip 35 includes a clip intermediate section 32, provided between the clip first and second End sections 22 and 28, that is selectively adjustable in length to selectively vary a distance between the clip first and second end sections 22 and 28. In the embodiment shown in the drawings, the clip intermediate section 32 includes a pair of substantially rigid tubes 34 having their ends coaxially engaged in the clip first and second end sections 22 and 28, which are physically separated from each other, and firmly fixed thereon through suitable adjustment screws 36.

In another alternate embodiment of a clip (not shown in the drawings), the clip is substantially similar to the second embodiment of the clip 35 described above, except that the tubes 34 are replaced with tubes made of a resilient material such as rubber, or equivalent, having their distal ends fixedly attached to the clip first and second end sections. The thus formed clip is also adjustable in length.

FIG. 7 illustrates yet another embodiment of a clip 40 usable in a lid securing device according to the invention. Clip 40 is generally represented by a substantially elongated and planar member that is sized and configured to substantially duplicate the lateral profile of clip 20. Likewise clips 20 and 35, clip 40 is typically made of a resilient yet sufficiently rigid and rust proof material such as, for examples, stainless steel, aluminum, or a suitable polymeric material.

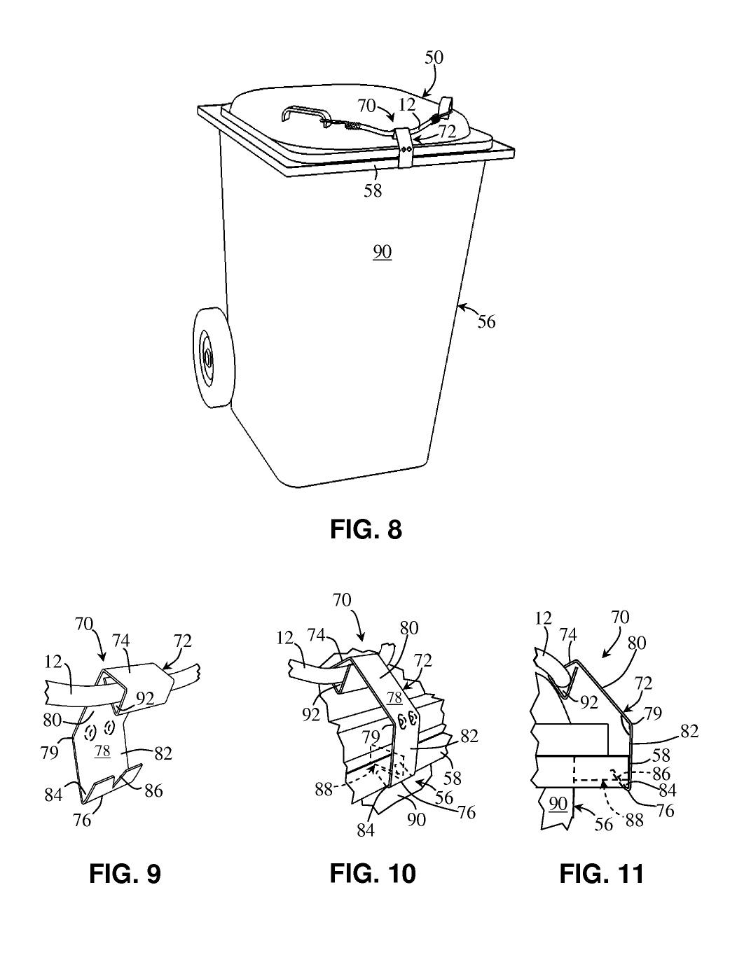

In yet another embodiment of the invention, as seen in FIG. 8, a lid securing device 70 similar to the lid securing device 10 described hereinabove includes a clip 72 that is substantially rigid. Referring to FIGS. 9 and 10, the clip 72 defines opposed clip first and second end sections 74 and 76 and a clip intermediate section 78 extending therebetween. The clip intermediate section 78 includes intermediate section first and second portions 80 and 82, the intermediate section first and second portions 80 and 82 extending respectively from the clip first and second end sections 74 and 76 and being joined to each other in a bend 79 formed in the clip intermediate section 78. The intermediate section first and second portions 80 and 82 are substantially planar and angled relative to each other, as better seen in FIG. 11. The intermediate section second portion 82 abuts against and is substantially parallel to the lip 58 when the lid securing device 10 is in the locked position.

In some embodiments of the invention, the clip second end section 76 is substantially V-shaped and defines a recess 84 receiving at least part of the lip 58 thereinto when the lid securing device 70 is in the locked position. Also, the clip second end section 80 may define a notch 86, better seen in FIG. 9, extending substantially longitudinally thereinto for receiving thereinto a substantially plate-shaped reinforcing member 88, seen in FIG. 10 for example, extending between the lip 58 and the peripheral wall 90 of some receptacles 56.

In some embodiments of the invention, the clip first end section 74 defines a passageway 92 receiving at least part of the stretchable element body 12 therethrough. For example, the stretchable element body 12 is slidable relative to the passageway 92. However, in alternative embodiments of the invention, the stretchable element body 12 is fixed relative to the passageway 92, or the clip 72 is mounted to the stretchable element body 12 in any other suitable manner.

For example, the clip 72 is a made of a single piece of folded sheet metal. However, other manufacturing methods and materials are within the scope of the present invention.

In some embodiments, recesses are punched in the bend 79 to reinforce the clip 72 so that the clip 72 is relatively rigid and cannot be easily bent further or straitened.

Although the present invention has been described hereinabove by way of preferred embodiments thereof, it can be modified, without departing from the spirit and nature of the subject invention as defined in the appended claims.

What is claimed is:

1. A lid securing device for a refuse container, said refuse container including a receptacle defining a top aperture, said refuse container also including a lid for selectively obstructing said top aperture, said lid defining a pair of lid attachments and said receptacle defining a receptacle attachment, said lid securing device comprising:
a stretchable element, said stretchable element including a stretchable element body, said stretchable element body being substantially elongated, flexible and resiliently stretchable, said stretchable element body defining substantially opposed stretchable element body ends, said stretchable element also including two attachment elements each mounted to said stretchable element body substantially adjacent a respective one of said stretchable element body ends, each of said attachment elements being attachable to a respective one of said lid attachments; and
a clip defining a clip first end section, a clip second end section and a clip intermediate section extending therebetween, said clip first end section being mounted to said stretchable element between said stretchable element body ends, said clip second end section being releasably attachable to said receptacle attachment;
wherein, when said attachment elements are attached to said lid attachments, said stretchable element body is stretchable by pulling on said clip so that said clip second end section can be attached to said receptacle attachment to secure said lid in a lid closed position in which said lid obstructs said top aperture.

2. A lid securing device as defined in claim 1, wherein said attachment elements each include a hook.

3. A lid securing device as defined in claim 1, wherein said attachment elements are removably attachable to said lid attachments.

4. A lid securing device as defined in claim 1, wherein said clip first end section defines a passageway receiving at least part of said stretchable element body therethrough.

5. A lid securing device as defined in claim 1, wherein said clip intermediate section is selectively adjustable in length to selectively vary a distance between said clip first and second end sections.

6. A lid securing device as defined in claim 1, wherein said clip is substantially rigid.

7. A lid securing device as defined in claim 6, wherein said clip intermediate section includes intermediate section first and second portions, said intermediate section first and second portions being substantially planar and angled relative to each other.

8. A lid securing device as defined in claim 1, wherein said clip second end section is substantially V-shaped and defines a recess for receiving said receptacle attachment thereinto.

9. A refuse container, said refuse container comprising:
a receptacle defining a top aperture and a receptacle attachment;
a lid, said lid defining substantially opposed lid first and second ends, said lid being hingedly mounted to said receptacle opposed to said receptacle attachment at said lid first end, said lid being movable between a lid open position and a lid closed position, said lid being removed from said top aperture in said lid open position and said lid obstructing said top aperture in said lid closed position, said lid defining a pair of lid attachments substantially adjacent said lid second end; and
a lid securing device including:
a stretchable element, said stretchable element including a stretchable element body, said stretchable element body being substantially elongated, flexible and resiliently stretchable, said stretchable element body defining substantially opposed stretchable element body ends, said stretchable element also including two attachment elements each mounted to said stretchable element body substantially adjacent a respective one of said stretchable element body ends, each of said attachment elements being attached to a respective one of said lid attachments; and
a clip defining a clip first end section, a clip second end section and a clip intermediate section extending therebetween, said clip first end section being mounted to said stretchable element between said stretchable element body ends, said clip second end section being releasably attachable to said receptacle attachment when said lid is in said lid closed position;
said lid securing device being reversibly movable between an unlocked position and a locked position, wherein, in said unlocked position, said clip second end section is detached from said receptacle attachment and said stretchable element body has a body first length, and, in said locked position, said clip second end section is attached to said receptacle attachment and said stretchable element body has a body second length longer than said body first length and is deformed towards said receptacle attachment.

10. A refuse container as defined in claim 9, wherein said lid defines a pair of handles, said handles defining said lid attachments.

11. A refuse container as defined in claim 10, wherein said attachment elements each include a hook.

12. A refuse container as defined in claim 9, wherein said attachment elements are detachable from said lid attachments.

13. A refuse container as defined in claim 9, wherein said body first length is larger or equal to an unstretched length of said stretchable element body.

14. A refuse container as defined in claim 9, wherein said clip first end section defines a passageway receiving at least part of said stretchable element body therethrough.

15. A refuse container as defined in claim 9, wherein said receptacle defines a receptacle flange extending peripherally relative to said top aperture and a lip extending downwardly from said receptacle flange at the outer periphery thereof, said lip defining said receptacle attachment, said clip second end section being attached to said lip when said lid securing device is in said locked position.

16. A refuse container as defined in claim 15, wherein said clip is substantially rigid and said clip intermediate section includes intermediate section first and second portions, said intermediate section first and second portions extending respectively from said clip first and second end sections, said intermediate section first and second portions being substantially planar and angled relative to each other, said intermediate section second portion abutting against and being substantially parallel to said lip when said lid securing device is in said locked position.

17. A refuse container as defined in claim 15, wherein said clip second end section is substantially V-shaped and defines a recess receiving at least part of said lip thereinto when said lid securing device is in said locked position.

18. A refuse container as defined in claim 17, wherein said clip second end section defines a notch extending substantially longitudinally thereinto.

19. A refuse container as defined in claim 9, wherein said clip is made of a single piece of folded sheet metal.
